(19) United States
(12) Patent Application Publication
(10) Pub. No.: US 2007/0121278 A1
(43) Pub. Date: May 31, 2007

(54) ARTICULATED DEVICE COMPRISING TWO RELATIVELY MOVABLE ELEMENTS

(75) Inventor: Gerhard Kruger, Hamburg (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 11/565,053

(22) Filed: Nov. 30, 2006

(30) Foreign Application Priority Data
Nov. 30, 2005 (DE) 10 2005 057 010.0

(51) Int. Cl. H02B 1/00

(52) U.S. Cl. 361/600

(57) ABSTRACT

An articulated device includes first and second elements movably connected by a pivot pin. Each element has a borehole. A metallic bearing bush having first and second collars is positioned within the first borehole. The pivot pin has first and second steps having different diameters with the diameter of the first step being larger than the diameter of the second step. The first step has a support head. The steps have a stop between them. The first step extends through the first borehole and is supported on the second element by the stop such that the collars of the bearing bush enclose a portion of the first element adjacent to the first borehole. The second step extends through the second borehole and is axially secured therein. At least one of the collars is shaped into an end position and the second step is fixed in place by a rivet head.

### CROSS-REFERENCE TO RELATED APPLICATIONS

This application claims foreign priority benefits under 35 U.S.C. § 119(a)-(d) to DE 10 2005 057 010.0, filed Nov. 30, 2005, which is hereby incorporated by reference in its entirety.

### BACKGROUND OF THE INVENTION

1. Field of the Invention

The present invention relates to an articulated device having two relatively movable elements such as two guide rods of a rod assembly for a movable motor vehicle roof, and relates to a method for connecting the relatively movable elements of the articulated device.

2. Background Art

DE 40 30 855 C2 describes a joint for the bearing of levers, rockers, or the like. The joint includes a pivot pin and two relatively movable guide rods. The pivot pin includes a support head and a shaft which accommodate boreholes in the guide rods. The pivot pin includes first and second step sections. The diameter of the first step section is larger than the diameter of the second step section, which by a closing head establishes the connection between the guide rods on a side facing away from the support head. A plastic bearing bush encloses the first step section. A stop guides the first step section on one of the guide rods.

DE 197 23 401 C1 describes first and second hinge portions which are combined so as to be relatively movable. A borehole in the first hinge portion includes a collar bushing. The collar of the collar bushing is guided around the outer boundary of the first hinge portion. A bearing bush having two cones is inserted into a borehole in the second hinge portion. An intermediate bushing is supported on the cone of the bearing bush facing the first hinge portion. An adjacent collar for the first hinge portion rests on an axial boundary of the bearing bush. A hinge pin and a nut hold both hinge portions in position. The hinge pin includes a head and passes through both hinge portions with the nut supported by one cone on the other cone of the bearing bush.

### SUMMARY OF THE INVENTION

An object of the present invention is an articulated device having two relatively movable elements in which the articulated device has a relatively simple design and satisfactory function.

Another object of the present invention is a method for manufacturing the articulated device in which the method is easily carried out and is operationally reliable.

In carrying out the above objects and other objects, the present invention provides an articulated device. The articulated device includes a first element having a first borehole and a second element having a second borehole. The articulated device further includes a metallic bearing bush having first and second radial collars. The bearing bush positioned within the first borehole. The articulated device further includes a pivot pin cooperating with the first and second elements to movably connect the first and second elements to one another. The pivot pin has first and second step sections having different diameters. The diameter of the first step section is larger than the diameter of the second step section. The first step section has a support head. The first and second step sections have a stop between them. The first step section extends through the first borehole of the first element and is supported on the second element by the stop such that the radial collars of the bearing bush enclose a portion of the first element adjacent to the first borehole. The second step section extends through the second borehole of the second element and is axially secured therein. At least one of the radial collars of the bearing bush is shaped into an end position and the second step section is fixed in place by a rivet head connecting the first and second elements.

Further, in carrying out the above objects and other objects, the present invention provides a method of manufacturing an articulated device having first and second guide rods, a pivot pin having first and second step sections in which the first step section has a support head, and a bearing bush having a prefabricated state in which the bearing bush includes first and second radial collars, the first step section having a support head. The method includes placing the first guide rod on a pressing and flanging device and positioning the bearing bush in its prefabricated state above the first guide rod. The method further includes pressing the bearing bush into a first borehole in the first guide rod such that the bearing bush projects from the first borehole with a free bushing section and has a preliminary flange forming the second radial collar. The method further includes combining the first guide rod and the bearing bush into a unit. The method further includes inserting the pivot pin into the first borehole in the first guide rod of the unit. The method further includes inserting the unit together with the pivot pin into a sizing device. The method further includes pressing the pivot pin together with the first step section into the first borehole through the bearing bush such that the second radial collar is shaped into a final flange. The method further includes bringing the support head of the first step section into contact with the first radial collar. The method further includes inserting the second step section of the pivot pin into the second borehole in the second guide rod such that a free end of the pivot pin projecting from the second borehole forms a rivet head.

An articulated device in accordance with an embodiment of the present invention includes two relatively movable elements. Each element is a guide rod of a rod assembly for a movable motor vehicle roof. The guide rods along with a pivot pin and a bearing bush form the articulated device which may be easily manufactured with exemplary functioning and durability. The collars for the bearing bush and the step sections of the pivot pin as well as the rivet head of the pivot pin contribute in this regard. A groove in the transition region between the support head and the first step section and/or a groove in the transition region between the stop of the first step section and the second step section ensures a targeted tolerance compensation. The method for manufacturing the articulated device is characterized by ease of conversion and excellent process reliability. The steps of the method may be practically implemented using automated technology.

The above features, and other features and advantages of the present invention as readily apparent from the following detailed descriptions thereof when taken in connection with the accompanying drawings.

### BRIEF DESCRIPTION OF THE DRAWINGS

An exemplary embodiment of an articulated device having two relatively movable elements, and a method for manufacturing the articulated device are described in further detail below with reference to the Figures in which:

FIG. 1 illustrates a cross-sectional view of the articulated device;

FIG. 2 illustrates a perspective view of the articulated device detail X shown in FIG. 1;

FIG. 3 illustrates a cross-sectional view of the articulated device detail Y shown in FIG. 1;

FIG. 4 illustrates a cross-sectional view of a section of the articulated device with respect to a first step of the method for manufacturing the articulated device;

FIG. 5 illustrates a cross-sectional view of a section of the articulated device with respect to a second step of the method;

FIG. 6 illustrates a cross-sectional view of a section of the articulated device with respect to a third step of the method;

FIG. 7 illustrates a cross-sectional view of a section of the articulated device with respect to a fourth step of the method;

FIG. 8 illustrates a cross-sectional of a section of the articulated device with respect to a fifth step of the method;

FIG. 9 illustrates a cross-sectional view of the articulated device with respect to a sixth step of the method;

FIG. 10 illustrates a cross-sectional view of the articulated device with respect to a seventh step of the method; and

FIG. 11 illustrates a cross-sectional view of the articulated device with respect to an eighth step of the method.

### DETAILED DESCRIPTION OF THE PREFERRED EMBODIMENT(S)

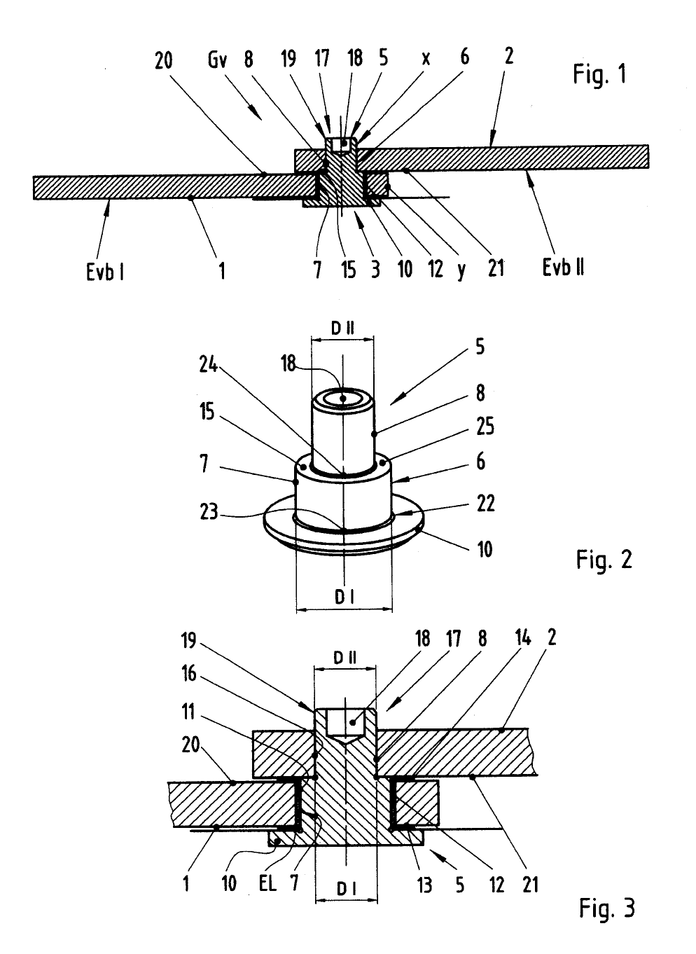

Referring now to FIGS. 1, 2, and 3, different views of an articulated device Gv in accordance with an embodiment of the present invention are shown. FIG. 1 illustrates a cross-sectional view of articulated device Gv. FIG. 2 illustrates a perspective view of the articulated device detail X shown in FIG. 1. FIG. 3 illustrates a cross-sectional view of the articulated device detail Y shown in FIG. 1.

Articulated device Gv includes two elements Evb I and Evb II which are relatively movable to one another. In this embodiment, element Evb I is a first guide rod 1 and element Evb II is a second guide rod 2. First and second guide rods 1, 2 are part of a rod assembly for a movable roof of a motor vehicle. First and second guide rods 1, 2 are relatively movable to one another to move the roof between a closed position in which the roof covers the vehicle interior and an opened position in which the roof is lowered to expose the vehicle interior.

A retaining device 3 movably connects first and second guide rods 1, 2 to one another. Retaining device 3 includes a pivot pin 5 which cooperates with first and second guide rods 1, 2 to movably connect the guide rods to one another. Pivot pin 5 includes a shaft 6 having a first step section 7 and a second step section 8. First step section 7 has a diameter D1 and second step section 8 has a diameter DII. Diameter DI of first step section 7 is larger than diameter DII of second step section 8.

Shaft 6 of pivot pin 5 includes a support head 10 which meets with the bottom surface of first guide rod 1. First step section 7 extends from support head 10 through a first borehole 11 in first guide rod 1. A bearing bush 12 is inserted to enclose first guide rod 1 with radial collars 13, 14 for axially securing bearing bush 12. A stop 15 on shaft 6 is between first and second step sections 7, 8. Second guide rod 2 rests on stop 15. Second step section 8 extends within a second borehole 16 in second guide rod 2 which axially secures second step section 8 on the top side 17 of second guide rod 2.

Bearing bush 12 is made of a suitable metal. At least one of collars 13, 14 is brought into an end position EL by shaping. A rivet head 19 having a recessed bore 18 for pivot pin 5 produces the axial securement. Rivet head 19 is likewise made of a suitable metal. Recessed bore 18 ensures the targeted formation of rivet head 19.

First and second guide rods 1, 2 are made of a metallic material respectively having flattened guide rod sections 20, 21. Guide rod sections 20, 21 are superposed and have a rectangular cross-section. Second guide rod 2 is in contact with collar 14 for first guide rod 1.

As shown in FIG. 2, a circumferential first groove 23 is in a first transition region 22 of pivot pin 5 between support head 10 and first step section 7. Circumferential first groove 23 is in the form of a recess. A similarly designed circumferential second groove 24 is in a second transition region 25 between stop 15 and second step section 8.

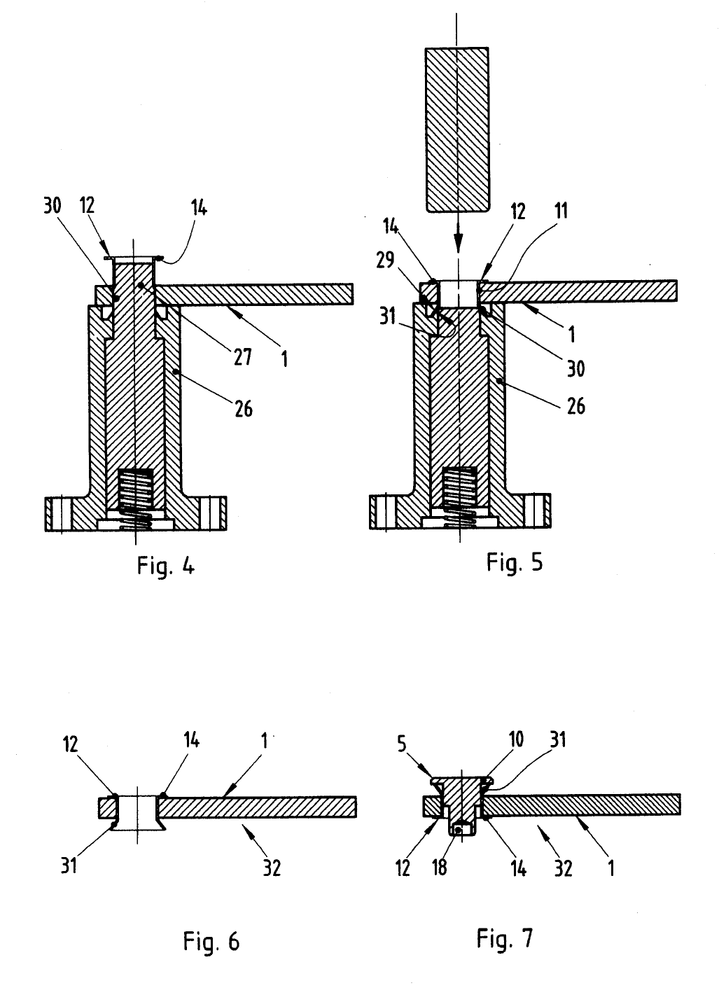

Referring now to FIGS. 4 through 11, individual steps of a method for manufacturing articulated device Gv in accordance with an embodiment of the present invention will now be described.

FIG. 4 illustrates a cross-sectional view of a section of articulated device Gv with respect to a first step of the method. In this step, first guide rod 1 is placed on a pressing and flanging device 26. Bearing bush 12 is situated above first guide rod 1. A bar 27 of pressing and flanging device 26 passes through first guide rod 1 and, in a sectional manner, through bearing bush 12.

FIG. 5 illustrates a cross-sectional view of a section of articulated device Gv with respect to a second step of the method. In this step, bearing bush 12 is pressed into first borehole 11 in first guide rod 1 by a stamp 28 in pressing and flanging device 26. As a result, a bearing bush section 29 projecting from first borehole 11 undergoes preliminary flanging 31 by a shaping cone 30 in pressing and flanging device 26.

FIG. 6 illustrates a cross-sectional view of a section of articulated device Gv with respect to a third step of the method. In this step, first guide rod 1 and bearing bush 12 are joined in the second step to form a prefabricated unit 32.

FIG. 7 illustrates a cross-sectional view of a section of articulated device Gv with respect to a fourth step of the method. In this step, pivot pint 5 in its prefabricated state is inserted into first borehole 11. That is, pivot pin 5 is inserted into bearing bush 12 for first guide rod 1 of unit 32.

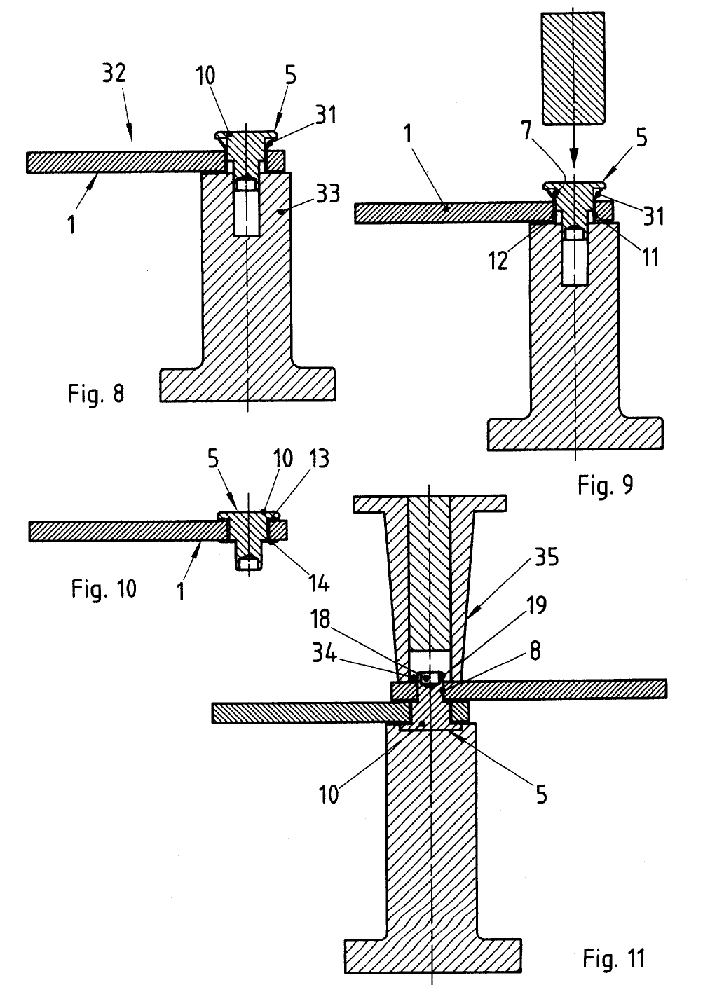

FIG. 8 illustrates a cross-sectional view of a section of articulated device Gv with respect to a fifth step of the method. In this step, unit 32 formed of first guide rod 1 and bearing bush 12 together with pivot pin 5 are inserted into a sizing device 33.

FIG. 9 illustrates a cross-sectional view of a section of articulated device Gv with respect to a sixth step of the method. In this step, pivot pin 5 together with its first step section 7 is pressed into first borehole 11. That is, pivot pin 5 together with its first step section 7 is pressed into bearing bush 12. First step section 7 of pivot pin 5 and first borehole 11 in first guide rod 1 are sized. Preliminary flange 31 is converted by shaping to the final flange form which forms collar 13.

FIG. 10 illustrates a cross-sectional view of a section of articulated device Gv with respect to a seventh step of the method. In this step, support head 10 of pivot pin 5 is brought into contact with collar 13.

FIG. 11 illustrates a cross-sectional view of a section of articulated device Gv with respect to an eighth step of the method. In this step, second step section 8 of pivot pin 5 is inserted into second borehole 16 of second guide rod 2. A free end 34 of pivot pin 5 projecting from second borehole 16 is formed as rivet head 19 by a riveting device 35.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. An articulated device comprising:
a first element having a first borehole;
a second element having a second borehole;
a metallic bearing bush having first and second radial collars, the bearing bush positioned within the first borehole; and
a pivot pin cooperating with the first and second elements to movably connect the first and second elements to one another, the pivot pin having first and second step sections having different diameters, the diameter of the first step section is larger than the diameter of the second step section, the first step section having a support head, wherein the first and second step sections have a stop between them;
wherein the first step section extends through the first borehole of the first element and is supported on the second element by the stop such that the radial collars of the bearing bush enclose a portion of the first element adjacent to the first borehole;
wherein the second step section extends through the second borehole of the second element and is axially secured therein;
wherein at least one of the radial collars of the bearing bush is shaped into an end position and the second step section is fixed in place by a rivet head.

2. The articulated device of claim 1 wherein:
the first element is a first guide rod and the second element is a second guide rod.

3. The articulated device of claim 2 wherein:
the second guide rod rests on the radial collar facing the second guide rod.

4. The articulated device of claim 2 wherein:
the second step section includes a recessed bore for the rivet head which connects the first and second guide rods.

5. The articulated device of claim 2 wherein:
a first circumferential groove is in a first transition region between the support head and the first step section.

6. The articulated device of claim 2 wherein:
a second circumferential groove is in a second transition region on the stop between the first and second step sections.

7. The articulated device of claim 2 wherein:
at least one guide rod is superposed with a flattened guide rod section.

8. The articulated device of claim 2 wherein:
at least one guide rod is metallic and has a rectangular cross section.

9. A method of manufacturing an articulated device having first and second guide rods, a pivot pin having first and second step sections, and a bearing bush having a prefabricated state, the method comprising:
placing the first guide rod on a pressing and flanging device; and
positioning the bearing bush in the prefabricated state above the first guide rod.

10. The method of claim 9 wherein the first guide rod includes a first borehole, the method further comprising:
pressing the bearing bush into the first borehole in the first guide rod such that the bearing bush projects from the first borehole with a free bushing section and has a preliminary flange.

11. The method of claim 10 further comprising:
processing the first guide rod and the bearing bush into a prefabricated unit.

12. The method of claim 11 further comprising:
inserting the pivot pin in a prefabricated state into the first borehole in the first guide rod of the unit.

13. The method of claim 12 further comprising:
inserting the unit together with the pivot pin into a sizing unit.

14. The method of claim 13 further comprising:
pressing the pivot pin together with the first step section into the first borehole through the bearing bush; and
shaping the preliminary flange of the bearing bush into a collar.

15. The method of claim 14 further comprising:
inserting the second step section of the pivot pin into the second borehole in the second guide rod such that a free end of the second step section projecting from the second borehole forms a rivet head.

16. A method of manufacturing an articulated device having first and second guide rods, a pivot pin having first and second step sections, and a bearing bush having a prefabricated state in which the bearing bush includes first and second radial collars, the first step section having a support head, the method comprising:
placing the first guide rod on a pressing and flanging device and positioning the bearing bush in its prefabricated state above the first guide rod;
pressing the bearing bush into a first borehole in the first guide rod such that the bearing bush projects from the first borehole with a free bushing section and has a preliminary flange forming the second radial collar;
combining the first guide rod and the bearing bush into a unit;
inserting the pivot pin into the first borehole in the first guide rod of the unit;
inserting the unit together with the pivot pin into a sizing device;
pressing the pivot pin together with the first step section into the first borehole through the bearing bush such that the second radial collar is shaped into a final flange;
bringing the support head of the first step section into contact with the first radial collar; and
inserting the second step section of the pivot pin into the second borehole in the second guide rod such that a free end of the pivot pin projecting from the second borehole forms a rivet head.
